(19) United States
(12) Patent Application Publication
(10) Pub. No.: US 2023/0136939 A1
(43) Pub. Date: May 4, 2023

(54) USER EXPERIENCE MODELING SYSTEM

(71) Applicant: Peircy Inc., Vancouver, WA (US)

(72) Inventors: Kirk George Kanzelberger, Steubenville, OH (US); James Bernard O'Kane, Morris Plains, NJ (US); Christopher Lee Stevenson, Westfield, NJ (US); Megan Jean Trinneer, Longview, WA (US)

(21) Appl. No.: 17/979,566

(22) Filed: Nov. 2, 2022

Related U.S. Application Data
(60) Provisional application No. 63/275,406, filed on Nov. 3, 2021.

(51) Int. Cl. G06N 5/02; G06N 5/04

(52) U.S. Cl. CPC G06N 5/027; G06N 5/041

(57) ABSTRACT

Time-series data and domain knowledge rules governing interpretation of the time-series data in building a semiotic model of a user are accessed. An experience event is extracted from the time-series data based on the rules. A triadic data structure is generated based on the event to include an object element, a sign element, and an interpretant element. The interpretant element is determined based on an observation associated with the rules. An object of interest that appears in the environment of the user during the experience event is identified based on the time-series data. The object element of the triadic data structure is determined based on the object of interest. The triadic data structure is added to the semiotic model as a hypothesis. Once validated, the triadic data structure represents an interpretive habit of the user.

### TECHNICAL FIELD

The present disclosure generally relates to data modeling, and more specifically, to systems for modeling user experience for predicting individual user behavior.

### BACKGROUND

Learning systems require vast amounts of training data. The learning systems also require significant computational resources to process the large amounts of training data required to train the systems to be able to perform tasks (e.g., classification, prediction, regression, etc.) with reasonable accuracy. Moreover, to optimize resource consumption, such systems are typically generalized to be applicable for all users (or a subset of user). Customizing such systems on a per-user basis is often impractical due to the computational expense involved.

### SUMMARY

This disclosure pertains to systems and methods for modeling the experience of individual users for respective representation of the individual experience of the user of objects in real and/or virtual environments and allowing for drawing of highly personalized inferences based on the individualized models. The systems and methods apply the principles of semiotics to conceptualize user experience and determine its representation in a data structure. For example, techniques disclosed herein look to draw a hypothetical inference about a user’s experience at a point in time (or duration) based on cooccurrences (predetermined based on domain knowledge rules) in time-series data derived from an array of sensors (and/or from a state of a virtual environment). The hypothetical inferences may be embodied in triadic data structures, each of which represents an experience event of a user as a relation of three terms: (A) an “object” present, imagined, anticipated or remembered, (B) a set of parameters (“signs”) qualifying the object for the individual in such a way as to elicit (C) a meaningful response (“interpretant”; e.g., action, emotion, cognition, and the like).

That is, the systems and methods may utilize the time-series data to build hypothetical representations of an individual’s experience in triadic data structures of triadic-relational elements relating the objects, signs, and interpretants. These triadic data structures may be linked to form a network in which the elements may be compared, and various kinds of logical connections established between the elements. The network of linked triadic data structures may be referred to as a (highly personalized) semiotic model corresponding to the individual user. The hypotheses represented in these triadic data structures may be confirmed via repeated observations of the corresponding predetermined cooccurrences and/or explicit confirmation from the user (e.g., via input on an interface of a device of the user). Once the hypotheses are confirmed, the network of the (confirmed) triadic data structures in the model may form the basis for drawing predictions about probable user behavior in situations similar to those that are represented (and confirmed) in the triads of the semiotic model. For example, the predictions may inform the user or another entity (e.g., a third party that makes business decisions based on predicted user behavior) about the way the user experiences (and therefore, likely to act upon) objects in their environment. Since the system does not rely on training data for training the system to generate each of the different types of triadic data structures, the amount of training data required for building the semiotic model is reduced, thereby reducing the amount of computational resources needed and thus reducing the computational expense involved. Further, since the semiotic models are built to be highly personalized to the user, user-specific behavior predictions can be made accurately.

By way of example, in one embodiment, a computer-implemented method includes a plurality of steps. The steps include a step of accessing time-series data associated with a user. The steps further include a step of accessing domain knowledge rules governing interpretation of the time-series data in building a semiotic model of the user. Still further, the steps include a step of extracting an experience event from the time-series data based on at least one of the domain knowledge rules being satisfied. Yet still further, the steps include a step of generating, based on the experience event, a triadic data structure comprising triadic-relational elements. The triadic-relational elements include an object element, a sign element, and an interpretant element. The interpretant element of the triadic data structure is determined based on an observation associated with the at least one domain knowledge rule. Still further, the steps include a step of identifying an object of interest that appears in the user’s environment during the experience event based on the time-series data associated with the experience event, where the object element of the triadic data structure is determined based on the object of interest. Yet still further, the steps include a step of adding the triadic data structure to the semiotic model of the user. And still further, the steps include a step of setting a habit flag of the triadic data structure in the semiotic model in response to determining that a predetermined condition associated with the triadic data structure is satisfied. The habit flag indicates that the triadic data structure represents an interpretive habit of the user.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a block diagram illustrating an example system environment, in accordance with some embodiments.

FIG. 1B is a block diagram of the representation engine of FIGS. 1, in accordance with some embodiments.

FIG. 2 shows an example of linked triadic data structures included in a semiotic model, in accordance with some embodiments.

FIG. 3 is a flowchart illustrating a process for generating a triadic data structure and adding the triadic data structure to a semiotic model, in accordance with some embodiments.

FIG. 4 is a block diagram illustrating components of an example computing machine, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

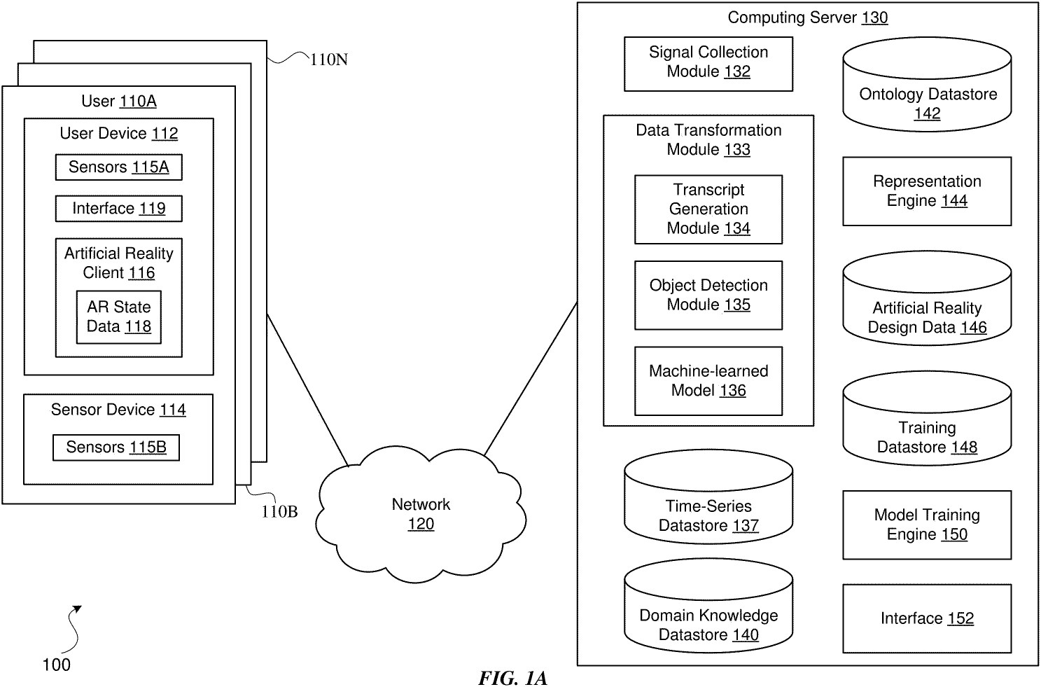

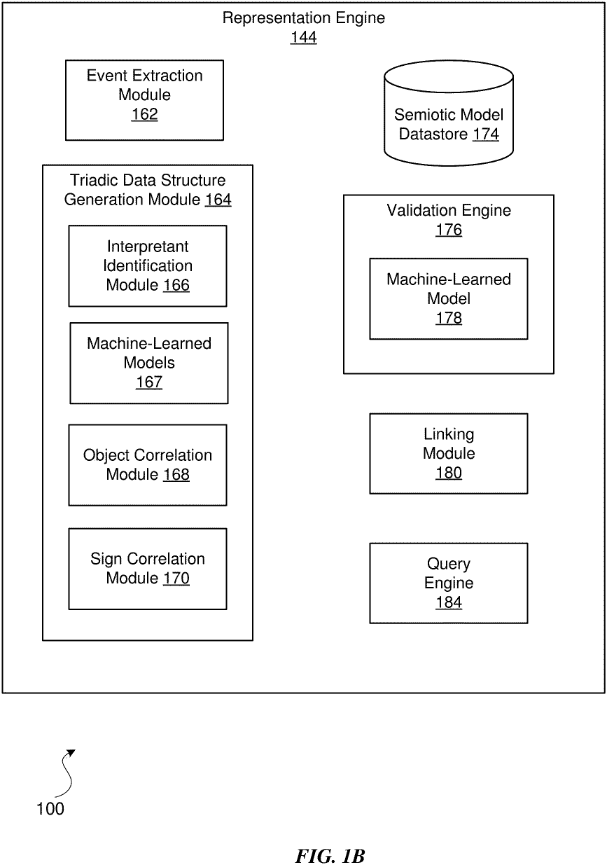

Referring now to FIG. 1A, shown is a block diagram illustrating an example system environment 100 for modeling user experience, in accordance with an embodiment. The system environment 100 may include a plurality of users 110 (110A, 110B, ..., 110N), a network 120, and a computing server 130. In different embodiments, the system environment 100 may include fewer or additional components. The system environment 100 may also include different components.

Each user 110 may be an individual (e.g., human person) whose experience is to be modeled by the computing server 130 in a corresponding personalized semiotic model of triadic data structures generated based on streams of time-series data associated with the user. In some embodiments, each user 110 may have a corresponding user device 112. Additionally, or alternately, each user may further have sensor device 114.

User device 112 may be a computing device capable of receiving user input as well as transmitting and/or receiving data to computing server 130 via network 120. For example, user device 112 may be a headset, headphone device, or head-mounted display (HMD). As another example, user device 112 may be a device having computer functionality, such as a desktop computer, a laptop computer, a personal digital assistant (PDA), a mobile telephone, a smartphone, a tablet, an Internet of Things (IoT) device, a virtual conferencing device, a cuff, or another suitable device. Although not depicted, each user device may have a screen for displaying content (e.g., content for validating triadic data structure hypothesis). A form factor of user device 112 may be designed to integrate a plurality of sensors 115A into the device. Sensor device 114 may be a wearable device that can be used to strap one or more biometric sensors 115B to be in contact with the skin of the user. Sensor device 114 may be communicatively coupled to user device 112.

Sensors 115 (115A, 115B) may include hardware to generate multimodal sensor data. For example, sensors 115 may include Galvanic Skin Response (GSR) and Electrodermal Activity (EDA) sensors to capture emotional status, emotional intensity, cognitive status, arousal, and physiological activation of the user. As another example, sensors 115 may include thermistor sensors to capture body temperature, and Photoplethysmography (PPG) sensors (red/infra-red/green) to capture heart rate (HR), heart rate variability (HRV), respiration, hydration, oxygen saturation, and the like. As another example, sensors 115 may include Skin Conductance (SC) response, humidity, and temperature sensors to capture perspiration, body temperature, health, arousal, and physiological activation. As another example, sensors 115 may include accelerometer and gyroscope sensors to capture movement, gestures, activities, and rotation of the user, and a magnetometer to capture cardinal direction. As another example, sensors 115 may include one or more of electrocardiogram (ECG or EKG) sensors, electrooculography (EOG), electroencephalography (EEG) sensors, or electromyogram (EMG) sensors. ECG captures heart’s electrical activity. EOG captures eye activity by measuring the corneo-retinal standing potential that exists between the front and the back of the human eye. EEG captures brain activity by recording an electrogram of the spontaneous electrical activity of the brain. EMG captures muscle activity by evaluating and recording the electrical activity produced by skeletal muscles. Sensors 115 may also include a microphone to capture audio data of the user and ambient sound, locomotion sensors that capture the bearing and speed of the user’s movement, and one or more image sensors (e.g., charge coupled device sensor, complimentary metal-oxide-semiconductor sensor, etc.) and passive motion sensors that capture information about the user’s ambient physical environment (e.g., image data or video data of the user (e.g., face of the user) and/or of the user’s ambient physical environment). Sensors 115 may also include additional sensors such as positional tracking sensors, image-based eye tracking sensors, and the like. In some embodiments, sensors 115 may also include a geolocation sensor (e.g., GPS sensor) to detect position, movement, etc. of the user in real-time. One or more of sensors 115 may capture the sensor data at a sampling rate (e.g., 250hz).

User device 112 may also include artificial reality client 116 for providing artificial reality content to the user. Artificial reality is a form of reality that has been adjusted in some manner before presentation to the user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). The content may present an artificial reality environment to the user and the user may interact with the artificial reality environment via a digital avatar of the user. The content presented in the artificial reality environment may include a plurality of objects. For example, the digital avatar of the user playing an artificial reality game having a scripted narrative based on game design may navigate through objects in the artificial reality environment and interact with the objects during game play to achieve predetermined game objectives. A state of the artificial reality environment (e.g., objects in the vicinity of the avatar of the user, virtual objects that appear in the user’s artificial reality environment, one or more parameters associated with the objects, etc.) may be stored in a time-series as artificial reality state data 118.

Interface 119 facilitates (e.g., wireless) connection of user device 112 to other devices (e.g., sensor device 114) and to computing server 130 via network 120. Interface 119, which may include hardware and/or software components, enables transfer of data generated by sensors 115 and/or transfer of artificial reality state data 118 to computing server 130 via network 120.

The computing server 130 may include one or more computing devices that cooperate to perform various tasks related to modeling user experience. Computing server 130 may be a distributed computing system (e.g., a decentralized computing system of multiple connected devices working in tandem). Computing server 130 may provide the semiotic model generation, maintenance and update of the model, and model querying features to users 110 as a form of cloud-based software, such as software as a service (SaaS), through network 120. For example, computing server 130 may retrieve various information such as sensor data, artificial reality environment state data, and metadata via suitable communication channels from user devices 112. Computing server 130 may perform calculations and analysis of the retrieved data and present the results (e.g., ability to query a semiotic model for user behavior predictions) through a graphical interface. Alternatively, or additionally, to the SaaS, computing server 130 may also perform the tasks thereof as a form of locally installed software.

The network 120 provides connections to the components of system environment 100 through one or more sub-networks, which may include any combination of local area and/or wide area networks, using both wired and/or wireless communication systems. In one embodiment, network 120 uses standard communications technologies and/or protocols. For example, network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over network 120 may be represented using any suitable format, such as hypertext markup language (HTML), extensible markup language (XML), JavaScript object notation (JSON), structured query language (SQL). In some embodiments, all, or some of the communication links of network 120 may be encrypted using any suitable technique or techniques such as secure sockets layer (SSL), transport layer security (TLS), virtual private networks (VPNs), Internet Protocol security (IPsec), etc. Network 120 also includes links and packet switching networks such as the Internet.

As shown in FIG. 1A, computing server 130 includes signal collection module 132, data transformation module 133, time-series datastore 137, domain knowledge datastore 140, ontology datastore 142, representation engine 144, artificial reality design data 146, training datastore 148, model training engine 150, and interface 152. Data transformation module 133 includes transcript generation module 134, object detection module 135, and machine-learned model 136. In different embodiments, the system environment 100 may include fewer or additional components. The system environment 100 may also include different components.

Signal collection module 132 receives multiple streams of data generated by one or more sensors 115 and/or by artificial reality state data 118 of user device 112 corresponding to user 110 via network 120. The data streams may be received from user device 112 in real-time, as the data streams are generated by the user interacting with their environment in the real world or in the virtual world. Alternately, the data streams generated by the user interacting with their environment in the real world or in the virtual world may be stored locally (e.g., on a storage device of user device 112), and the stored data may be later transmitted to signal collection module 132 for processing and building of a corresponding semiotic model to model the experience of the user based on their streams of data.

The data streams received by signal collection module 132 may be processed by data transformation module 133 to be in a standardized, machine-readable format for subsequent processing. For example, the user’s heart rate data stream (detected by a PPG sensor) may be output by data transformation module 133 in beats per minute, the user’s movement (captured by accelerometer and gyroscope sensors) may be output in miles per hour, the user’s bearing (captured based on the accelerometer, gyroscope, and magnetometer sensors) may be output as value between 0 and 360 degrees relative to true north at a predetermined frequency that is based on the sampling rate at which the sensor data is captured by the corresponding sensors, etc.

Transcript generation module 134 may generate a transcript based on the audio data stream captured by the microphone of user device 112 and/or based on audio content feed included in artificial reality state data 118. For example, transcript generation module 134 may generate a transcript of the user’s “audio journal” including the user’s vocal utterances as the user interacts with their physical or virtual environment. The transcript may also include transcription based on vocal utterances of others in the immediate physical or virtual environment of the user. For example, in the virtual world context, content feed associated with artificial reality state data 118 may enable transcript generation module 134 to generate a transcription based on vocal utterances of the user as well as others in the immediate virtual environment of the user. Transcript generation module 134 may use transcription software, which relies on speech recognition (e.g., speech-to-text), to automatically generate a transcript of received data. Transcript generation module 134 may further use natural language processing or natural language understanding techniques to perform processing on the transcript to perform tasks like identifying the current speaker (e.g., user or another person), identifying objects in a cooccurring image data stream based on reference to the object in the audio data, etc. In some embodiments, transcript generation module 134 adjusts the transcript based on user input. The transcripts generated by transcript generation module 134 may be stored.

Object detection module 135 detects instances of objects of one or more types or classes (e.g., groups of humans, animals, etc.) in the image or video data stream captured by the one or more image sensors and passive motion sensors of user device 112 that capture information about the user’s ambient physical environment. Object detection module 135 may also be configured to detect instances one or more objects of one or more object types or classes in the digital content feed of the artificial reality environment that the user is interacting with and that is included in artificial reality state data 118.

In some embodiments, object detection module 135 uses computer vision and image processing techniques. For example, object detection module 135 may use supervised machine learning techniques such as support vector machines (SVM) and convolutional neural networks (CNN) to identify one or more objects in an input image/digital data and classify each object into an object type the object detection module 135 is trained to detect based on the unique features of each object class or type. Object detection module 135 may further be configured to detect position information for each detected object instance relative to the field of view of the user. For example, for each object instance, object detection module 135 may determine the bearing of the object relative to the user (or the digital avatar of the user in case of the virtual environment).

In some embodiments, object detection module 135 is configured to detect, out of the detected object instances in the image data, an object of interest (e.g., physical, or virtual object that appears in the environment of the user) indicating an instance of a type of object to which the user’s attention is directed to. Machine-learned model 136 may be trained to identify the object of interest that appears in the user’s environment based on one or more streams of the time-series data. For example, training data may be used to train machine-learned model 136 so that a feature vector generated based on multiple streams of the time-series data (e.g., cooccurring audio data, transcript of the audio data, object instances detected in the image data, contextual information, eye tracking data, gaze data, EOG data, pupillometry data, artificial reality environment design data, etc.) can be input to the trained machine-learned model 136 to determine the likelihood of one of the object instances as being the object of interest.

Data generated by data transformation module 133 from the input streams of data received from user device 112 is output as standardized streams of time-series data that is correlated with each other so that cooccurring experience events in the different streams (e.g., the appearance of an object in the field of view of the user accompanied by an increase in heart rate and/or change in direction or speed of movement of the user) of data can be identified. The streams of time-series data generated by data transformation module 133 may be stored in time-series datastore 136 along with schematic data and metadata such as identification information identifying the user associated with the time-series data.

Non-limiting examples of the different streams of time-series data generated by data transformation module 133 include: HR (heart rate) stream, with regions tagged that represent the elevation of the user’s heart rate as exceeding some threshold above a baseline; LOCSPEED (locomotion speed) stream, with changes of speed within a predetermined time interval tagged as either SLOWDOWN or SPEEDUP; LOCBEAR (locomotion bearing) stream, with changes of bearing greater than a threshold tagged as DEFLECT; PPL (presence of people), a time series of tuples (nₚₚₗ, dₚₚₗ, bₚₚₗ) representing estimated number of individuals, approximate distance and bearing; VOC (user vocal utterance), tagged with NLP parser outputs that have been classified as containing user references to presence of objects (e.g., groups of other people) in the user’s environment. Another example of a stream of time-series data generated by data transformation module 133 can include an image data stream tagged with an object of interest indicating the object in the user’s environment to which the user’s attention is directed to.

Domain knowledge datastore 140 includes data and rules that define knowledge and nomenclature in specific domains associated with semiotic model (e.g., domains or areas in which the semiotic model is able to make predictions about user behavior). Domain knowledge may include semantic networks relating to object types, situation types, human response types, and the like. The networks may specify how objects in a knowledge domain are or may be related and classified according to relevant user-independent perspectives. To make inferences about the user’s experience, domain knowledge datastore 140 may include domain knowledge rules of a general type and independent of a particular user’s experience and the specific sensor data from the user that is tied to their particular experience. Domain knowledge datastore 140 furnishes invariant or relatively invariant premises or general rules necessary to form hypotheses about what the time-series data might mean in relation to user experience. Domain knowledge datastore 140 may embody or encode domain knowledge in a variety of ways. For example, rules expressive of the domain knowledge may be baked into the semiotic model itself, or encoded and stored in a semantic network, ontology, graph, or other kind of knowledgebase or rule base. Non-limiting examples of domain knowledge rules that may be included in domain knowledge datastore 140 may include one or more rules as further described herein.
Rule R1. A rule that sudden, significant deflections of the user’s movement and bearing are (a) experience events, and (b) probable indicators of the user’s intention to avoid or distance their self from some object in the near environment, or their intention to approach more closely some object in the environment.
Rule R2. A rule that sudden increase of the user’s moving speed accompanying a deflection of bearing are (a) experience events of interest, and (b) increase the probability that the user has an intention to either avoid or approach some object in the environment.
Rule R3. A rule that periods of elevated user heart rate are (a) experience events of interest, and (b) probable indicators of the presence of a strong emotion.
Rule R4. A rule that the ambiguities present in R2 and R3 may be resolved with probability by a knowledge of the object to which the user’s attention is directed during the relevant time interval, and the bearing of that object relative to the user.
Rule R5. A rule that the number, distance, and relative bearing of a group of people relative to the user are salient characters of that object type for an interpreter who has a tendency to take action to avoid groups of people
Rule R6. A rule that a deflection of bearing that satisfies certain criteria in relation to the bearing of a group of people relative to the user is a probable indicator that the group of people is an object of interest and the object of avoidance or distancing, and that the probability is increased by an increase in the speed of movement.
Rule R7. A rule that a deflection of bearing that satisfies certain criteria in relation to the bearing of a group of people relative to the user is a probable indicator that the group of people is an object of interest and the object of approach, and that the probability is increased by an increase in the speed of movement.
Rule R8. A rule that an increase of user heart rate may indicate either the excitement of wanting to approach or the aversion of wanting to avoid an object of interest or attention.
Rule R9. A rule that the user’s vocal reference in the audio data to the presence of a group of people is a probable indicator of the group being the object of interest during some time interval inclusive of the vocal reference and helps to confirm probable inferences such as R5 and R6.
Rule R10. A rule that the user’s avoidance or distancing from an object of a certain type is a probable indicator of the presence of an internal habit of the user that governs their probable behavior in similar future circumstances.

Ontology datastore 142 stores a plurality of ontologies related to the domain(s) of knowledge for which data and rules are stored in domain knowledge datastore 140 and which pertain to the semiotic models being developed for the users. Each ontology may encompass a representation, formal naming, and definition of the categories, properties, and relations between the concepts, data, and entities that substantiate one or more of the domains. More simply, an ontology is a way of showing, by way of interconnected nodes, the properties of a subject area and how they are related, by defining a set of concepts and categories that represent the subject. The ontologies in ontology datastore 142 may include one or more domain ontologies (or domain-specific ontologies) that represent concepts that belong to a particular realm, e.g., animals, aural stimuli, emotions, etc. The ontologies in ontology datastore 142 may further include an upper ontology (or foundation ontology) that models commonly shared relations and objects that are generally applicable across a wide range of domain ontologies.

Based on observations derived from the rules that are satisfied, and based on identified objects of interest, hypothetical inferences can be derived connecting object, sign, and interpretant. The references to the three elements of the triadic data structure, i.e., object, sign, and interpretant, may be implemented as pointers to elements in the corresponding same or different ontologies (e.g., taxonomies), where additional knowledge about those elements may be available. For example, if the identified object of interest is a “dog,” the triad’s reference to an object or the object element may be a pointer to a node of a taxonomy or ontology of animals. If the sign is “loud barking,” the reference to a sign or the sign element may be a pointer to an element of an ontology of aural stimuli. If the interpretant is the feeling of “fear,” the reference to an interpretant or the interpretant element of the triad may be a pointer to a node of an ontology of emotions. The connection between the triad elements and the domain ontologies is useful for explaining the content of triadic data structures of the semiotic models, making further inferences based on semiotic models, and adding new triadic data structures linked to the existing triadic data structures in the semiotic models through the testing of new hypotheses based on the domain knowledge and domain ontologies applied to existing triads.

Thus, based on, e.g., cooccurring audio journal data from the user (and corresponding object-tagged transcript data) corresponding to the same experience event, additional highly personalized hypothetical inferences can be automatically derived that link interpretants into a learning spiral chain of interpretants connected to the same object. A web of such linked semiotic triads personalized to the user may thus be able to generate an inference signal that predicts user behavior in highly specific and personalized situations and outputs that information to the user or to third parties that may use that information for different use cases. The model is semiotic, that is, the user’s experience is modeled as a sign-process, that is, a process that elicits cognitive, emotional, and energetic or action interpretants in relation to an object manifested by signs (e.g., parameters associated with the object).

Representation engine 144 builds and dynamically maintains a semiotic model representing a particular user’s experience in one or more domains, where the general knowledge relevant to the one or more domains (i.e., the areas of experience being modeled) is stored in domain knowledge datastore 140 and in the ontology datastore 142. Representation Engine 144 uses the built semiotic model to generate its own high-level signals (i.e., predictions of user behavior) in response to external queries or other external or internal prompts.

The discipline of semiotics holds that a person’s experience is always contextual and is always the experience of an object in terms of some sign or signs, which may be thought of as a set of parameters expressing how the object appears (or might be appearing) to this person in a given context. For a person to “experience” any object is to interpret that object on the basis of how it appears (i.e., its signs), yielding outcomes called interpretants.

The conception of an “interpretant” is distinctive of semiotics. An interpretant may be a cognition (e.g., a judgment such as, “That is a big dog”, “That dog is dangerous”, or “This beach is quite crowded”), an emotion (e.g., actual fear of a particular dog, or a sense of aversion to the crowd on the beach), or an action (e.g., moving away from the dog or that area of the beach).

A further distinctive claim of semiotics is that these interpretive outcomes themselves function as signs of the same object in their turn, eliciting further interpretants or elaborations in experience. For example, the appearance of a particular dog may elicit a judgment recognizing that “That is a big dog”, an interpretant that undergoes further interpretive development in the judgment “That dog is dangerous”, but also in the feeling itself of fear (an emotional interpretant), and in the action itself of moving away from the dog (an energetic interpretant).

In other words, not only the cognition but the emotion and the action as well are meaningful: they are different kinds of “translation” of the same original sign (the appearance of the dog, or some other aggressive behavior of the dog like loud barking) of the same object (the dog itself). Thus, interpretants of a given sign of an object generally develop as a series or “chain” of interpretants, that will continue to develop until the possibilities inherent in the original sign (at least for this individual interpreter) are exhausted.

In light of the foregoing principles of semiotics, representation engine 144 builds a semiotic model that represents an individual’s experience by means of structural elements (e.g., triadic data structures) that have three references: a reference to an object, a reference to a sign (or signs) expressing how the object appears to the user (e.g., one or more parameters of the object), and a reference to an interpretant (i.e., the interpretive response on the part of the individual).

An “object” may be anything to which the user may relate through a cognitive act, or anything about or concerning which the user may take some particular action or elicit some particular behavior. An object may be a particular entity, process, relationship, or a particular property or character of such. An object may be qualified as present, past, possible future, imagined, or fictional. An object may be understood either as an individual instance (token) of a general type or as the type itself. The nature of an object may be physical, cultural, or an amalgam of the two.

A “sign” may be any vehicle through which an object is made known, or makes itself known, to an interpretive agent (the user), in some context. For example, the features or behavior or parameters of an object are signs taken by an interpreter to convey something specific about an object. For example, the behavior (parameters) of barking and giving chase (sign) may be taken by the user to convey aggressiveness (interpretant) in a dog (object). Another kind of sign is a symbolic vehicle used by human interpretive agents deliberately to communicate with each other, as in natural language utterances. For example, the verbal assurance of a dog’s owner to the effect that the dog is friendly and that the barking and chasing behavior is in this context a form of play, is a sign.

An “interpretant” may be the interpretive outcome of semiosis, reflecting how the user takes the object of experience as it is disclosed to them by its signs. Interpretive outcomes are of different kinds, which may be ranged under cognitive, emotive, and active or energetic(behavioral) interpretants as broad types. An interpretant may be of a more immediate kind, reflecting how an object appears to a user, or is taken by a user, before the user has had a chance to reflect. Or an interpretant may be an outcome shaped in the long run through repeated or related experiences of objects of a certain kind. Such settled outcomes can be considered to be interpretive habits regarding objects of that kind.

### Example Representation Engine

Referring now to FIG. 1B, representation engine 144 includes event extraction module 162, triadic data structure generation module 164, semiotic model datastore 174, validation engine 176, linking module 180, and query engine 184. Triadic data structure generation module 164 includes interpretant identification module 166, machine-learned models 167, object correlation module 168, and sign correlation module 170. Validation engine 176 includes machine-learned model 178. In different embodiments, representation engine 144 may include fewer or additional components. Representation engine 138 may also include different components.

Event extraction module 162 may extract an experience event from the time-series data generated by data transformation module 133. In some embodiments, event extraction module 162 may access the time-series data associated with the user whose semiotic model is being built from time-series datastore 137. Event extraction module 162 may further access domain knowledge rules governing interpretation of the time-series data in building the semiotic model of the user from domain knowledge datastore 140. Event extraction module 162 may extract the experience event based on at least one of the domain knowledge rules being satisfied.

The different streams of tagged time-series data are time synchronized. Event extraction module 162 may apply a moving window (e.g., corresponding to a period of 10 seconds) to the streams of data to observe, identify, and extract time-correlated events from the time-series data based on the domain knowledge rules. The domain knowledge rules may describe conditions (e.g., triggers based on predetermined thresholds being reached for biometric data, geolocation data, or locomotion data, triggers based on NLP parsing of user’s vocal utterances, and the like) based on which a corresponding snippet of time-series data may be extracted as an experience event.

For example, object detection module 135 may detect an object of interest in the user’s environment and its position relative to the user, and further event extraction module 162 may detect biometric triggers like a threshold change in the heart rate of the user accompanied by physical triggers based on geolocation data indicating a change in direction of the user’s movement to be away from the object of interest. Domain knowledge datastore 140 may include rules that are triggered when such time-correlated events are detected. The rules may include observations of what can be interpreted (e.g., action of moving away, positive emotion, negative emotion, more specific types of emotions like fear, excitement, anger, etc.) from the time-correlated events if the rule(s) is triggered. Based on the triggered domain knowledge rules, event extraction module 162 may extract the corresponding time-correlated events (as conveyed by the different streams of tagged time-series data) as an experience event.

As another example, event extraction module 162 may apply above illustrative set of rules R1-R10 to the tagged time-series data and determine several types of experience events of interest (e.g., sudden change of movement bearing, increased movement speed, elevated heart rate). For example, event extraction module 162 may extract from the time-series data LOCBEAR, LOCSPEED and HR, a set of event correlations representable by tuples of the form:
(t1, t2, b, Δb, s, Δs, Δr, v)

where t1 and t2 delimit a time interval of length less than some upper bound (e.g., 10 seconds) in which a significant change of bearing Δb takes place. The remaining values are as follows: b is the (original) bearing of the user, Δb is the change in bearing, s is the user’s movement speed, Δs is the change in movement speed over the interval [t1, t2] (if any), Δr is the elevation (if any) of user heart rate above baseline during interval [t1, t2], and v is the NLP-parsed content of any user vocal utterances during interval [t1, t2]. The output may be a set ∑ of observations that are derived from the triggered rules and that pertain to the user. In semiotic terms, the observations are signals of possible interpretants of an, e.g., energetic and/or emotional type, i.e., actions and emotions interpretively responding to objects.

Triadic data structure generation module 164 generates triadic data structures based on the experience events extracted by event extraction module 162. Each triadic data structure includes triadic-relational elements. The triadic-relational elements include an object element, a sign element, and an interpretant element. Interpretant identification module 166 determines the interpretant element of the triadic data structure based on the observation associated with the triggered domain knowledge rule.

For example, based on the observation of the triggered rule, the interpretant identification module 166 may determine the interpretant to be the act of moving away from some object, the emotion of fear, etc. Triadic data structure generation module 164 may generate a new triadic data structure where the interpretant element is populated based on the observation gleaned from the triggered domain knowledge rule(s). For example, interpretant identification module 166 may search one or more ontologies (e.g., action ontology, emotion ontology) relevant to the domain of the triggered rule to identify a node in an ontology that matches the observation of the triggered rule and populates the interpretant element of the new triadic data structure with a pointer to the identified ontology node.

As another example, interpretant identification module 166 may represent the set of observations ∑ illustrated above as possible user interpretants of objects by creating a corresponding set of triadic data structures containing a reference to an interpretant (I), while leaving the references to object (O) and sign (S) blank or null:

| | | |
|---|---|---|
| O | S | I |
| (null) | (null) | Reference to interpretant |

Each triadic data structure in the set may be represented as: { (O, S, I) : σ, f, C }, where O, S, I may be instantiated with respective data pointers to corresponding ontology nodes, or may be instantiated with null values, and where σ, f, and C represent optional auxiliary data: σ representing a data pointer to background data associated with the corresponding observation, f representing a habit flag to indicate whether the triadic data structure has been validated, and C representing a data pointer to a situational context (e.g., limiting meaning of the relation described by the triadic data structure to a particular context or domain).

Continuing with the above example of the set of observations ∑, interpretant identification module 166 may create the following traids:
1. { ((null), (null), &approach) : σ, f }
2. { ((null), (null), &avoidance) : σ, f }
3. { ((null), (null), &emotion) : σ, f }

In the above examples, the references &approach, &avoidance, and &emotion are pointers into behavioral and emotional ontologies (e.g., taxonomies) defining those terms and any experience-independent properties they may have. Habit flag f in each triad may not be set to show that the triad is a hypothesis that is modeling a particular experience that is bound to a particular time instance and has not been validated yet to be set as a general habit of the user. Background data σ may be used for further processing to assess the relative likelihood of the completed hypothesis, when the null references for object and sign are filled in.

In some embodiments, machine-learned models 167 may be trained to determine the interpretant element of the triadic data structure based on the observation of the triggered rule and further based on the time-series data associated with the extracted event. That is, the time-series data associated with the experience event may be input into a machine-learned model 167 corresponding to the type of observation to predict an interpretant candidate, and the interpretant element may be determined based on the predicted interpretant candidate.

That is, machine-learned models 167 may respectively correspond to the different (higher-level) observation types (e.g., observation type is emotion) included in the domain knowledge rules in domain knowledge datastore 140, and each machine-learned model 167 may be trained to predict based on an input snippet of data corresponding to the extracted experience event, an (lower-level) interpretant candidate (e.g., predicted type of emotion) having a highest likelihood. For example, training data may be used to train machine-learned model 167 so that a feature vector is generated based on the domain knowledge observation type and further based on the snippet of multiple streams of the tagged time-series data corresponding to the extracted event (e.g., cooccurring audio data, transcript of the audio data, object instances detected in the image data, contextual information based on the observation, biometric data, environmental data, etc.) can be input to the trained machine-learned model 167 to determine the likelihood of one of multiple interpretant candidates (in a given observation domain) being the likely interpretant for the experience event.

Interpretant identification module 166 may then determine the interpretant element of the triadic data structure corresponding to the extracted experience event based on the interpretant candidate output from the machine-learned model 167. For example, interpretant identification module 166 may search one or more ontologies (e.g., action ontology, emotion ontology) relevant to the domain of the observation to identify a node in an ontology that matches the interpretant candidate and populates the interpretant element of the new triadic data structure with a pointer to the identified ontology node. Alternately, interpretant identification module 166 may cause the interpretant element to be stored as a data token.

Object correlation module 168 determines the object element of the triadic data structure generated by triadic data structure generation module 164 and whose interpretant element is determined by interpretant identification module 166. Object correlation module 168 determines the object element based on an object of interest that appears in the user’s environment during the experience event corresponding to the triadic data structure. The object of interest for the experience event may be determined based on the time-series data associated with the experience event. In some embodiments, object correlation module 168 determines the object element of the triadic data structure based on the object of interest identified by object detection module 135. In other embodiments, object correlation module 168 determines the object element of the triadic data structure based on an observation of a triggered domain knowledge rule in domain knowledge datastore 140. Object correlation module 168 may search one or more ontologies (e.g., animal ontology) relevant to the domain of the identified object of interest (or observation of a triggered domain knowledge rule) to identify a node in an ontology that matches the identified object of interest and populates the object element of the triadic data structure with a pointer to the identified ontology node.

Sign correlation module 170 determines the sign element of the triadic data structure generated by triadic data structure generation module 164 and whose interpretant element is determined by interpretant identification module 166 and object element is determined by object correlation module 168. Sign correlation module 170 determines the sign element based on the corresponding object element. For example, the sign element may be one or more parameters corresponding to the object of interest and may be captured in one or more streams of the time-series data associated with the experience event. That is, sign correlation module 170 determines the sign element of the triadic data structure based on the time-series data associated with the experience event. Sign correlation module 170 may use data from the ontologies corresponding to the object element and the interpretant element to determine the types of parameters the object of interest may have, and based on the determination, sign correlation module 170 may identify parameter data in the time-series data snippet corresponding to the experience event. Sign correlation module 170 may further perform a classification operation to classify the parameter data in the time-series, and based on the classification, identify the one or more parameters of the object of interest. Sign correlation module 168 may search one or more ontologies (e.g., aural stimuli ontology) relevant to the domain of the identified object of interest (or observation of a triggered domain knowledge rule) to identify a node in an ontology that matches the identified one or more parameters of the object of interest and populates the sign element of the triadic data structure with a pointer to the identified ontology node.

Continuing with the above example where triadic data structures for the set of observations ∑ are respectively populated with corresponding interpretant elements, object correlation module 162 correlates the hypothetical interpretants of the triadic data structures with objects that appear in some manner in the user’s environment. As explained above, these probable correlations to the object account for cooccurrence (by being from the same extracted event time-series data) and further for the object being the object of interest by determining that the identified object has the user’s attention during the event’s time interval. For example, the object of interest may be identified to be a group of one or more people in the near environment of the user. This object type may be denoted by Γ. Occurrences of objects of type Γ may be tagged in the time-series data PPL along with three parameters: approximate number of individuals (nₚₚₗ), approximate distance (dₚₚₗ), and bearing (bₚₚₗ).

In some embodiments, to determine whether the object of type Γ is the object of interest for one or more of the set of observations ∑, object correlation module 168 applies the domain knowledge rules in domain knowledge datastore 140 and filters the set of observations ∑ based on the results. For example, let θ denote the positive angular difference between the bearing of such an object of type Γ relative to the user and the user’s bearing b. Object correlation module 168 may select all triads from the set ∑ that cooccur with an object of type Γ (based on the object-tagged time-series PPL), for which the value of θ increases by a predetermined amount (e.g., 30 degrees) from a threshold when the user’s bearing changes from b to b + Δb. These triads indicate instances of the user moving away from the object. Based on the above selection, triad(s) in T_{avoid} are updated to represent the hypothetical inference that they represent aversion and avoidance in relation to objects of type Γ:
{ ((null), (null), &avoidance) : σ, f } ⇒ { (&Γ, (nₚₚₗ, dₚₚₗ, bₚₚₗ), &avoidance) : σ, f }
{ ((null), (null), &emotion) : σ, f } ⇒ { (&Γ, (nₚₚₗ, dₚₚₗ, bₚₚₗ), &aversion) : σ, f }

Similarly, object correlation module 168 may select all triads from the set ∑ that cooccur with an object of type Γ (based on the object-tagged time-series PPL), for which the value of θ decreases by a predetermined amount (e.g., 30 degrees) from an initial value. These triads indicate instances of the user moving toward or to face the object. Based on the above selection, triad(s) in T_{approach} are updated to represent the hypothetical inference that they represent attraction and approach in relation to objects of type Γ:
{ ((null), (null), &approach) : σ, f } ⇒ { (&Γ, (null), &approach) : σ, f}
{ ((null), (null), &emotion) : σ, f } ⇒ { (&Γ, (null), &attraction) : σ, f }

In the updated triads, the reference to an object &Γ may include a universally unique identifier denoting the instance of the object of this type, and a pointer into an object ontology that contains just this one general object type Γ (human person group). The more refined emotional interpretants &aversion and &attraction are pointers into the same emotional ontology as the more generic &emotion. Further, as shown above, sign correlation module 170 updates the sign element of the avoidance triad with a tuple of parameter values (nₚₚₗ, dₚₚₗ, bₚₚₗ) representing characters of the object of type Γ. In accordance with rule R8, these are the characters of the object (number of people, distance, bearing) that are relevant to a tendency on the user’s part to take action to avoid a group of people. Sign correlation module 170 may keep the reference to a sign as null in the approach triad as there is no evidence or domain knowledge rule for what characters of a group of people might elicit attraction and approach on the part of the user.

The triadic data structure(s) generated by triadic data structure generation module 164 based on the extracted event may be added to the semiotic model corresponding to the user and stored in semiotic model datastore 174. As explained previously, in some embodiments, each of the three triads may be a pointer to an ontology that provides additional contextual information for the object, sign, or interpretant element. In other embodiments, one or more of the object, sign and interpretant elements may store data tokens generated and output respectively by object correlation module 168, sign correlation module 170, and interpretant identification module 166. Thus, the system is able to generate a semiotic model having triadic data structures that can represent relationships among the object, sign, and interpretant elements that are more granular (or nuanced) than what can be represented by using existing ontologies. For example, in building the semiotic model, the system may start with existing ontologies characterizing and organizing relationships and providing context among concepts and elements in a particular domain, but then the system may build on the ontologies to generate highly personalized and user specific triads that may be logically linked to the ontologies in a network of connected triades based on, e.g., user recorded audio data in conjunction with other streams of the time-series data.

Object elements, sign elements, and interpretant elements of distinct triads of a semiotic model corresponding to a particular user may have same or similar references (e.g., point to same nodes or related nodes in an ontology). For example, as evident from the corresponding ontology structure, object elements of two triads may be of the same type or same instance, or the object elements may be related as being subtype/supertype of each other or related according to any other type of logical relationship representable in an ontology. Similar relationships may be inferred for the sign elements or interpretant elements of the triads as well. Based on the inferences of how triads in the semiotic model are related or connected to each other, the system can perform further automated reasoning to generate further predictive hypotheses. That is, additional triads may be generated based on the logical relationships defined by the domain knowledge stored in domain knowledge datastore 140, without the collection of any additional data (e.g., time-series data). For example, if the user appears to feel and behave in a certain way in response to a certain type of object (e.g., a large dog) on the basis of certain signs, the system can reason to a probable similar response to other kinds of object that may present similar signs (e.g., some other kind of animal that is not a dog). Representation engine 144 may perform the processing described above for a plurality of users based on respective time-series data and build corresponding semiotic models in the manner described above and store the models in semiotic model datastore 174.

Validation engine 176 may set a habit flag of the triadic data structure in the semiotic model stored in semiotic model datastore 174 to identify the triadic data structure as indicating the user’s habit based on which inferences about future user behavior in certain situations can be drawn. That is, the habit flag indicates that the triadic data structure represents an interpretive habit of the user. Validation engine 176 may set the habit flag based on determining that a predetermined condition associated with the triadic data structure is satisfied.

In some embodiments, validation engine 176 may determine that the predetermined condition has been satisfied based on user feedback. For example, validation engine 176 may control interface 152 that orchestrates interactivity with user device 112 of the user to transmit a notification to the user. The notification (e.g., interactive graphical user interface) may present information regarding the interpretant element, the object element, and the sign element of the triadic data structure as a hypothesis. The user may interact with the transmitted information via a client application interface deployed on user device 112 to view the information and determine accuracy of the information. For example, the transmitted information of the triadic data structure may indicate a large dog as the object and barking and aggressive behavior of the dog as signs, and fear as the interpretant. The user may interact with the client application interface to validate (or refute or modify) the hypothesis by providing input via appropriate channels (e.g., peripheral devices like keyboard and mouse). For example, the client application interface may enable the user to change the interpretant element by presenting a slider or track bar to allow the user to set or adjust a value associated with the emotion (e.g., higher than hypothesis value means a negative emotion stronger than fear, lower than hypothesis value means a negative emotion weaker than fear, etc.).

As another example, the hypothesis represented in any triad may be translated into natural language in an interrogative form and presented to the user via the client application interface. An exemplary natural-language translation for a hypothetical triad might be the following: “Did you just have a response of I to an O that appears like S?”. Or, in case of continuing with the above example: “Did you just take action to avoid that group of approximately 8 people appearing at a bearing of 10 o-’clock at a distance of 10 yards?”.

Once a hypothesis has been validated by validation engine 176, the habit triad may be presented to the user as follows: “Do you think you have a tendency to have a response of I to an O that appears like S?”. Or, in case of continuing with the above example: “Do you think you have a tendency to take action to avoid groups of people in your near environment when you are out walking alone?” The user’s confirming or disconfirming response to the query may be recorded in the auxiliary data of the triad representing the hypothesis, and taken into account by any later heuristics and computations of confidence measures involving that hypothesis.

The client application interface may also allow the user to change the object and sign elements, or to reject the hypothesis entirely if, e.g., the object is not the cause of the interpretant identified in the triad. Based on the input received from user device 112, validation engine 176 may validate the hypothesis by setting the habit flag for the triadic data structure to true.

In some embodiments, validation engine 176 may calculate a confidence value for the triadic data structure that has been added to the semiotic model and determine that the predetermined condition is satisfied based on the confidence value being higher than a threshold. For example, validation engine 176 may determine the confidence level based on a number of triadic data structures that are added to the semiotic model and that meet a predetermined similarity threshold with respect to the triadic data structure.

As the time-series data is captured and processed by representation engine 144 over time, patterns may be captured in respective triadic data structures that are similar to each other. For example, a user walking their dog daily while using the system may experience similar emotions (e.g., fear caused by encountering another big dog) or take similar actions (e.g., moving away from the big dog) on multiple different occasions, and each occasion may be extracted as an experience event and a corresponding triadic data structure may be generated. Further, the object, sign, and interpretant elements in such triads may have the respective same or similar pointers to ontology nodes or store respective same or similar data tokens. Validation engine 176 may compare the triads with each other to detect such similarity and based on the similarity being higher than a predetermined similarity threshold, group such triads into a group and assign a confidence value to the group that increases based on the number of similar triads in the group. Validation engine 176 may thus set the habit flag for the triad (or group of similar triads) to true based on the confidence level. In some embodiments, validation engine 176 may employ machine-learned model 178 to calculate the confidence level.

Continuing with the above example where triadic data structures for the set of observations ∑ are respectively populated with corresponding interpretant elements, as more sessions are recorded and the set of observations ∑ expands, if triads of the kind previously created continue to be constructed from new observations, then when some heuristic (e.g., predetermined condition) is satisfied, validation engine 176 may draw a further kind of hypothetical inference, namely that the triads of this form represent an interpretive habit of the user.

For example, the habit flag may be set to indicate that this kind of triad represents a pattern of interpretive response that is not bound to a particular interval of time, but rather a general interpretive disposition affecting future user behavior. A habit hypothesis may be generated from a single instance of modeled experience, or it may be generated from a set of modeled experiences of the same object type. The heuristic that is used for determining habit hypothesis may be thought of as a confidence function over all factors deemed relevant that are available to the platform. In the present example, these factors could include, but need not be limited to, a weighting or averaging function, additional criteria derived from domain knowledge, and/or additional facts pertaining to specific observations.

A weighting or averaging function computed over a set of triads could be as simple as computing the cardinality of the set, or a complex calculation involving characters nppl, dppl, bppl over all observations, the number of triads that contain an emotional interpretant as well as an energetic interpretant, as well as additional facts. An example of the latter would be the presence of the user’s verbal reference to an object of type Γ in an observation σ, which is a confirming evidence of the user’s attention being directed to such an object, in accordance with rule R9. The hypothetical inference drawn by validation engine 176 may be represented by a triad of a form:
{ (&Γ, (|n|, |d|, |b|), &avoid) : {σi }}
where {σi } is a pointer to all the observational data (e.g., all triads in the group of triads of this kind) underlying the creation of this triad. The habit flag of this triad is set so as to mark the triad as modeling a pattern of interpretive response to a type of object not bound to a particular time but rooted in a habit of interpretation that may be expected to affect future user behavior. The sign-parameter tuple (|n|, |d|, |b|) may represent, respectively, a reduction of the values of parameters nppl, dppl, and bppl over the set of observations by, e.g., taking the mean of the numbers of people.

Linking module 180 may link triads in the semiotic model based on the same experience event and based on the triads having the same object and sign elements, but different interpretant elements. That is, the object element of a first triad may be a pointer to a node of a first ontology, the sign element of the first triad may be a pointer to a node of a second ontology, and the interpretant element of the first triad may be a pointer to a node of a third ontology. Further, triadic data structure generation module 164, based on the same experience event that created the first triad, may generate a second triad in which the object element is a pointer to the same node as the first triad’s object element, and the sign element is a pointer to the same node as the first triad’s sign element. In this case, linking module 180 may link the pointer corresponding to the interpretant element of the first triad to a pointer to a node of a given ontology (or to a stored data token) corresponding to the interpretant element of the second triad.

That is, if two triads have a reference to the same object and the same sign, but reference to differing interpretants, linking module 180 may chain the interpretants to create a new triad with the same references to object and sign, and with the reference to an interpretant being a pointer to an array or linked list of multiple interpretants. Chaining interpretants may involve another inference on part of the semiotic model since the chain represents a thread of experience of the user during a given experience event (e.g., heart rate elevation followed by movement away from the object of interest both caused by the same object and same signs).

Query engine 184 enables the user or another entity to predict future behavior of the user based on the triadic data structures added to the semiotic model and that have the set habit flag. For example, query engine 184 may interact with interface 152 to receive a query from an external device to the semiotic model of the user. The query may include data corresponding to an object and one or more parameters associated with the object. Query engine 184 may parse triadic data structures with set habit flags in the semiotic model of the user for object elements and sign elements that respectively match the object and the one or more parameters of the received query. Query engine 184 may thus identify a triadic data structure from the parsed triadic data structures based on the match and generate a response to the query based on the interpretant element of the identified triadic data structure. Query engine 184 may further control interface 152 to transmit the response to the external device. The response predicts a probable behavior of the user in a given situation (as defined by the received object and one or more parameters).

Referring again to FIG. 1A, artificial reality design data 146 may include data and domain knowledge defining how the artificial reality experience corresponding to artificial reality client 116 works, and how is intended to be to be experienced by users. For example, in case the artificial reality environment corresponds to a virtual reality game, AR design data 146 may define the scripted narrative of the game and include gameplay data which is the interaction between the player and the mechanics and systems and virtual objects of the game, game rules data which define the rules and objects in the game, and player experience data which is how users feel when they are playing the game, etc.

In embodiments where computing server 130 is building the model based on the user interaction with the artificial reality environment, object detection module 135 may identify the object of interest by identifying a virtual object of interest in the artificial reality environment based on artificial reality environment state data 118 and further based on design data 146 associated with the artificial reality environment.

Model training engine 150 trains machine-learned models of computing server 130. Model training engine 150 accesses data for training the models in training datastore 148. Training data can include time-series data stored in time-series datastore 137 and generated by data transformation module 133 based on data received from user device 112 of user 110. The training data can further include data and rules stored in domain knowledge datastore 140, ontology data and relationships stored in ontology datastore 142, and artificial reality design data 146.

Model training engine 150 may submit data for storage in training datastore 148. Model training engine 150 may receive labeled training data from a user or automatically label training data (e.g., using computer vision, NLP, NLU, etc.). Model training engine 150 uses the labeled training data to train a machine-learned model. In some embodiments, model training engine 150 uses training data labeled with indications of what the object of interest is in a given snippet of time-series data. In some embodiments, model training engine 150 uses training data labeled with indications of what the interpretant element of a triad is for corresponding feature data based on time-series data including one or more streams like tagged data like audio data, biometric data, physiological data, environmental data, geolocation data, locomotion data, image data, etc. Model training engine 150 also uses training data labeled with indications of a triad whose habit flag is set based on similarity of the triad with other triads in the semiotic model.

In some embodiments, model training engine 150 uses user feedback to re-train machine-learned models. Model training engine 150 may curate what training data to use to re-train a machine-learned model based on a measure of satisfaction provided in the user feedback. For example, model training engine 150 receives user feedback indicating that a user is highly satisfied with objects identified as of interest in respective extracted experience events. Model training engine 150 may then strengthen an association between the time-series data and object of interest output by creating training data using the time-series data and machine-learned model outputs associated with the high satisfaction to re-train one or more of the machine-learned models. In some embodiments, model training engine 150 attributes weights to training data sets or feature vectors. Model training engine 150 may modify the weights based on received user feedback and re-train the machine-learned models with the modified weights. By training a machine-learned model in a first stage using training data before receiving feedback and a second stage using training data as curated according to feedback, model training engine 150 may train machine-learned models of computing server 130 in multiple stages.

Interface 152 is an interface for a user and/or a third-party software platform to interact with computing server 130. Interface 152 may be a web application that is run by a web browser on a user device or a software as a service platform that is accessible by user device 112 through network 120. In one embodiment, interface 152 may use application program interfaces (APIs) to communicate with user devices or third-party platform servers, which may include mechanisms such as webhooks.

### Example Triadic Data Structure Linking Process

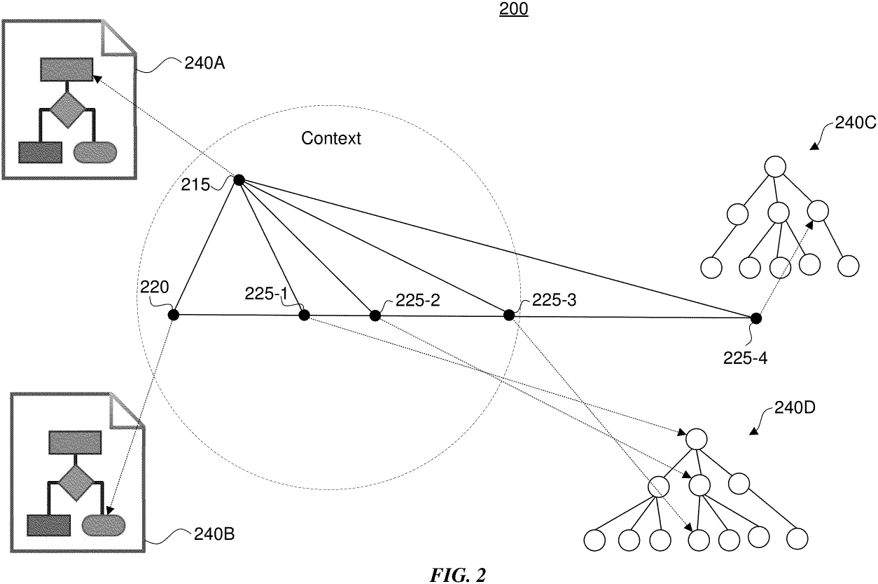

FIG. 2 shows an example of linked triadic data structures 200 included in a semiotic model, in accordance with some embodiments. As explained previously, the system builds semiotic models including triadic data structures for users based on the principles of semiotics. Each generated semiotic data structure includes object element 215, sign element 220, and interpretant element 225 (225-1, 225-2, 225-3, 225-4). For example, object element 215 may be a dog in the user’s physical environment, and appearance of the dog to the user (and its parameters like big size, barking, etc.) may be sign element 220. Based on the processing performed by computing server 130 using the time-series data, the system may identify interpretant element 225-1 as a cognition (e.g., a judgment such as, “That is a big dog”) based on e.g., audio journal data concurrent with the experience event. Further, during the same experience event, the system may generate additional triads for the same object element 215 and sign element 220. For example, the system may identify interpretant element 225-2 as another cognition in the thread of user experience (e.g., a judgment such as, judgment “That dog is dangerous”) based on e.g., audio journal data concurrent with the experience event. Similarly, the system may identify interpretant element 225-3 as an emotive interpretant based on the user’s acquired cognizance (e.g., an emotion of fear) based on e.g., biometric data concurrent with the experience event.

Still further, the system may identify interpretant element 225-4 as an energetic interpretant in the thread of user experience (e.g., the act of the user moving away from the dog) based on e.g., locomotion data, geolocation data, or gyroscope and accelerometer data concurrent with the experience event. In generating each triad, the system may consider the context information 230 to determine whether the link between the object, sign, and interpretant presents a reasonable hypothesis that can be added to the model of the user’s experience (i.e., the semiotic model). Further, as schematically shown in FIG. 2, the triadic data structures may be linked to each other (e.g., by linking module 180), since they have the same object and sign elements. Each of the object element 215, sign element 220, and interpretant elements 225 of the triads may be populated as pointers to nodes in respective (same or different) ontologies 240 (e.g., 240A, 240B, 240C, 240D) based on observations in triggered domain knowledge rules and based on the time-series data corresponding to the experience event.

Although not shown in FIG. 2, object element 215, sign element 220, and interpretant element 225 can “change places” between one triad and another (e.g., the sign element of one triad being the interpretant element of another triad) and the system can automatically reason and draw inferences based on the connections between the triads. Further, although FIG. 2 illustrates the inferences being automatically drawn based on the relations between the triads, this may not necessarily be the case. For example, indexes and other auxiliary structures could be built to optimize the discovery of the inferences.

### Example Semiotic Model Building Process

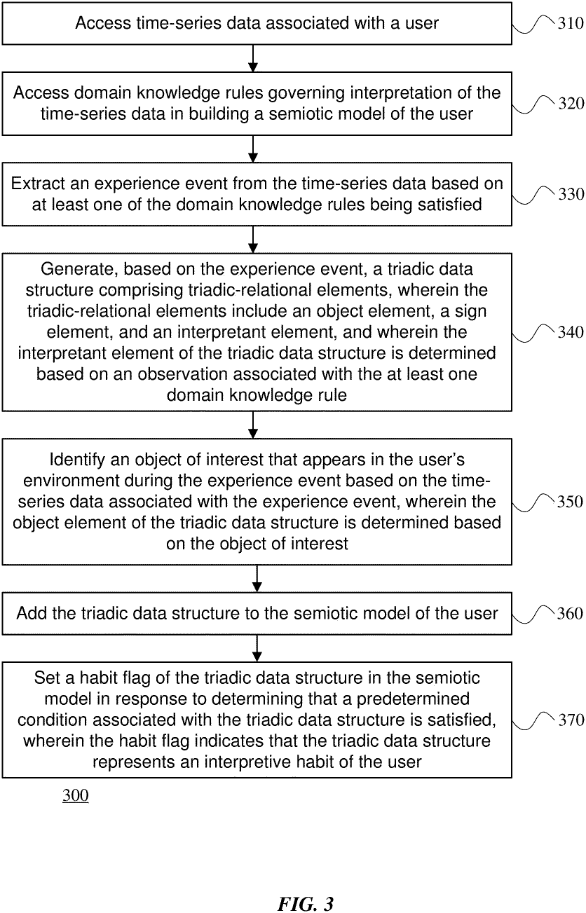

FIG. 3 is a flowchart illustrating process 300 for generating a triadic data structure and adding the triadic data structure to a semiotic model, in accordance with some embodiments. One or more components of computing server 130 may perform process 300. In some embodiments, the components of computing server 130 perform operations of process 300 in parallel or in different orders or may perform different steps.

Representation engine 144 accesses 310 time-series data associated with a user. The time-series data may be stored in time-series datastore 137. The time-series data may be associated with a particular user whose semiotic model is being built by computing server 130 using the time-series data. The data may be received (and model built) in real-time, as the user’s device is generating the data, or the data may be stored by the user’s device after capture and sent to computing server 130 later for model building.

Representation engine 144 accesses 320 domain knowledge rules governing interpretation of the time-series data in building a semiotic model of the user. The domain knowledge rules may be stored in domain knowledge datastore 140 and include rules and data governing creation of triads in particular domains for the user.

Representation engine 144 may extract 330 an experience event from the time-series data based on at least one of the domain knowledge rules being satisfied. Based on the experience event, representation engine 144 may generate 340 a triadic data structure comprising triadic-relational elements. The triadic-relational elements include an object element, a sign element, and an interpretant element. The interpretant element of the triadic data structure is determined based on an observation associated with the at least one domain knowledge rule.

Representation engine 144 (or object detection module 135) may identify 350 an object of interest that appears in the user’s environment during the experience event based on the time-series data associated with the experience event. The object element of the triadic data structure is determined based on the object of interest. The object and interpretant elements of the triad may be pointers to nodes of ontologies or may be data tokens generated based on the processing performed by representation engine 144 on the time-series data associated with the experience event.

Representation engine 144 may add 360 the triadic data structure to the semiotic model of the user. The triad may be linked with other triads in the model to form a network of triads based on which inferences about the user’s behavior in specific situations can be drawn. Representation engine 144 may set 370 a habit flag of the triadic data structure added at step 360 in the semiotic model in response to determining that a predetermined condition associated with the triadic data structure is satisfied. The habit flag indicates that the triadic data structure represents an interpretive habit of the user.

### Example Computing Machine Architecture

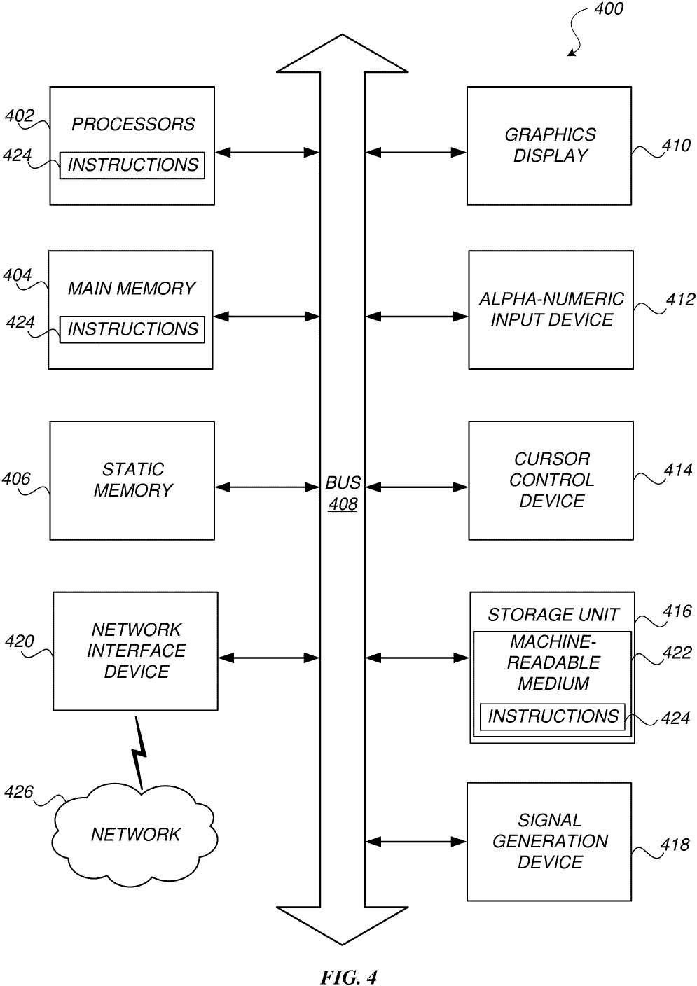

FIG. 4 is a block diagram illustrating components of an example computing machine that is capable of reading instructions from a computer-readable medium and execute them in a processor (or controller). A computer described herein may include a single computing machine shown in FIG. 4, a virtual machine, a distributed computing system that includes multiples nodes of computing machines shown in FIG. 4, or any other suitable arrangement of computing devices.

By way of example, FIG. 4 shows a diagrammatic representation of a computing machine in the example form of a computer system 400 within which instructions 424 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 4 may correspond to any software, hardware, or combined components shown in FIGS. 1A-B, including but not limited to, user devices 112, sensor devices 114, computing server 130, and various engines, interfaces, terminals, modules, and machines shown in FIGS. 1A-1B. While FIG. 4 shows various hardware and software elements, each of the components described in FIG. 4 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine (e.g., decentralized/web3 node) capable of executing instructions 424 that specify actions to be taken by that machine. Further, while only a single machine is illustrated, the term “machine” and “computer” may also be taken to include any collection of machines that individually or jointly execute instructions 424 to perform any one or more of the methodologies discussed herein.

The example computer system 400 includes one or more processors 402 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 400 may also include a memory 404 that store computer code including instructions 424 that may cause the processors 402 to perform certain actions when the instructions are executed, directly or indirectly by the processors 402. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 402 and reduces the space required for the memory 404. For example, the machine learning methods described herein reduces the complexity of the computation of the processors 402 by applying one or more novel techniques that simplify the steps in training, reaching convergence, and generating results of the processors 402. The algorithms described herein also reduces the size of the models and datasets to reduce the storage space requirement for memory 404.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 400 may include a main memory 404, and a static memory 406, which are configured to communicate with each other via a bus 408. The computer system 400 may further include a graphics display unit 410 (e.g., a plasma display panel (PDP), a liquid crystal display (LCD), a projector, or a cathode ray tube (CRT)). The graphics display unit 410, controlled by the processors 402, displays a graphical user interface (GUI) to display one or more results and data generated by the processes described herein. The computer system 400 may also include alphanumeric input device 412 (e.g., a keyboard), a cursor control device 414 (e.g., a mouse, a trackball, a joystick, a motion sensor, or other pointing instrument), a storage unit 416 (a hard drive, a solid state drive, a hybrid drive, a memory disk, etc.), a signal generation device 418 (e.g., a speaker), and a network interface device 420, which also are configured to communicate via the bus 408.

The storage unit 416 includes a computer-readable medium 422 on which is stored instructions 424 embodying any one or more of the methodologies or functions described herein. The instructions 424 may also reside, completely or at least partially, within the main memory 404 or within the processor 402 (e.g., within a processor’s cache memory) during execution thereof by the computer system 400, the main memory 404 and the processor 402 also constituting computer-readable media. The instructions 424 may be transmitted or received over a network 426 via the network interface device 420.

While computer-readable medium 422 is shown in an example embodiment to be a single medium, the term “computer-readable medium” should be taken to include a single medium or multiple media (e.g., a centralized or distributed database, or associated caches and servers) able to store instructions (e.g., instructions 424). The computer-readable medium may include any medium that is capable of storing instructions (e.g., instructions 424) for execution by the processors (e.g., processors 402) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

Beneficially, a computing server that extracts unstructured data of a domain to generate various process models may reduce the computing time of the domain in identifying a process and generating data structure related to unstructured data. The computing server achieves efficient and effective data and process management of the domain by extracting objects and connecting objects and events from various unstructured sources that are seemingly unrelated. This allows processes that are conventionally challenging to discover to be automatically and systematically identified and optimized. This also reduces the complexity of databases by allowing unstructured data to play a role in generating meaningful processes and structured information, sometimes without the need of converting the text and documents in unstructured sources to structured databases.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g., method, can be claimed in another claim category, e.g., computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method, comprising:
accessing time-series data associated with a user;
accessing domain knowledge rules governing interpretation of the time-series data in building a semiotic model of the user;
extracting an experience event from the time-series data based on at least one of the domain knowledge rules being satisfied;
generating, based on the experience event, a triadic data structure comprising triadic-relational elements, wherein the triadic-relational elements include an object element, a sign element, and an interpretant element, and wherein the interpretant element of the triadic data structure is determined based on an observation associated with the at least one domain knowledge rule;
identifying an object of interest that appears in the environment of the user during the experience event based on the time-series data associated with the experience event, wherein the object element of the triadic data structure is determined based on the object of interest;
adding the triadic data structure to the semiotic model of the user; and
setting a habit flag of the triadic data structure in the semiotic model in response to determining that a predetermined condition associated with the triadic data structure is satisfied, wherein the habit flag indicates that the triadic data structure represents an interpretive habit of the user.

2. The method of claim 1, further comprising predicting future behavior of the user based on a plurality of triadic data structures that are added to the semiotic model and that have the set habit flag.

3. The method of claim 1, further comprising:
receiving a query from an external device to the semiotic model of the user, the query including an object and one or more parameters associated with the object;
parsing triadic data structures with set habit flags in the semiotic model of the user for object elements and sign elements that respectively match the object and the one or more parameters of the received query;
identifying a triadic data structure from the parsed triadic data structures based on the match;
generating a response to the query based on the interpretant element of the identified triadic data structure; and
transmitting the response to the external device, wherein the response predicts a probable behavior of the user in a given situation.

4. The method of claim 1, wherein the time-series data includes a plurality of streams of data, the plurality of streams being generated based on at least one of sensor data and artificial reality environment state data, and
wherein the sensor data includes one or more of biometric data, locomotion data, geolocation data, audio data, image data, video data, or environmental data, associated with the user.

5. The method of claim 4, wherein the artificial reality environment state data includes information regarding a state of one or more virtual objects in an artificial reality environment of the user during the experience event, and
wherein identifying the object of interest comprises identifying a virtual object of interest in the artificial reality environment based on the artificial reality environment state data and further based on design data associated with the artificial reality environment.

6. The method of claim 1, further comprising determining the sign element of the triadic data structure based on the time-series data associated with the experience event.

7. The method of claim 6, wherein the object element of the triadic data structure is a pointer to a node of a first one of a plurality of ontologies, and the sign element of the triadic data structure is a pointer to a node of a second one of the plurality of ontologies, and the interpretant element of the triadic data structure is a pointer to a node of a third one of the plurality of ontologies.

8. The method of claim 7, wherein the triadic data structure is a first triadic data structure, and wherein the method further comprises:
determining that the object element of a second triadic data structure generated from the experience event and added to the semiotic model is a pointer to the same node of the first one of the plurality of ontologies;
determining that the sign element of the second triadic data structure is a pointer to the same node of the second one of the plurality of ontologies; and
in response to the determining, linking the pointer corresponding to the interpretant element of the first triadic data structure to a pointer to a node of a given one of the plurality of ontologies corresponding to the interpretant element of the second triadic data structure.

9. The method of claim 1, wherein setting the habit flag based on the predetermined condition comprises:
transmitting a notification to the user to present the triadic data structure as a hypothesis for validation based on user input; and
in response to determining that the hypothesis has been validated by the user, setting the habit flag for the triadic data structure.

10. The method of claim 1, wherein setting the habit flag based on the predetermined condition comprises:
determining a confidence level for the triadic data structure added to the semiotic model; and
setting the habit flag of the triadic data structure based on the confidence level being higher than a threshold.

11. The method of claim 10, wherein the confidence level is based on a number of triadic data structures that are added to the semiotic model and that meet a predetermined similarity threshold with respect to the triadic data structure.

12. The method of claim 1, further comprising inputting the time-series data associated with the experience event into a machine-learned model corresponding to the observation to predict an interpretant candidate, wherein the interpretant element is determined based on the predicted interpretant candidate.

13. The method of claim 1, further comprising inputting the time-series data associated with the experience event into a machine-learned model to predict the object of interest.

14. A system, comprising:
a user device generating sensor data associated with a user; and
a computing server comprising memory and at least one processor, the memory comprising instructions executable by the at least one processor, the instructions when executed, cause the at least one processor to:
access time-series data generated based on the sensor data;
access domain knowledge rules governing interpretation of the time-series data in building a semiotic model of the user;
extract an experience event from the time-series data based on at least one of the domain knowledge rules being satisfied;
generate, based on the experience event, a triadic data structure comprising triadic-relational elements, wherein the triadic-relational elements include an object element, a sign element, and an interpretant element, and wherein the interpretant element of the triadic data structure is determined based on an observation associated with the at least one domain knowledge rule;
identify an object of interest that appears in the environment of the user during the experience event based on the time-series data associated with the experience event, wherein the object element of the triadic data structure is determined based on the object of interest;
add the triadic data structure to the semiotic model of the user; and
set a habit flag of the triadic data structure in the semiotic model in response to determining that a predetermined condition associated with the triadic data structure is satisfied, wherein the habit flag indicates that the triadic data structure represents an interpretive habit of the user.

15. The system of claim 14, wherein the instructions, when executed, further cause the at least one processor to:
receive a query from an external device to the semiotic model of the user, the query including an object and one or more parameters associated with the object;
parse triadic data structures with set habit flags in the semiotic model of the user for object elements and sign elements that respectively match the object and the one or more parameters of the received query;
identify a triadic data structure from the parsed triadic data structures based on the match;
generate a response to the query based on the interpretant element of the identified triadic data structure; and
transmit the response to the external device, wherein the response predicts a probable behavior of the user in a given situation.

16. The system of claim 14, wherein the instructions, when executed, further cause the at least one processor to determine the sign element of the triadic data structure based on the time-series data associated with the experience event.

17. The system of claim 16, wherein the object element of the triadic data structure is a pointer to a node of a first one of a plurality of ontologies, and the sign element of the triadic data structure is a pointer to a node of a second one of the plurality of ontologies, and the interpretant element of the triadic data structure is a pointer to a node of a third one of the plurality of ontologies.

18. The system of claim 17, wherein the triadic data structure is a first triadic data structure, and wherein the instructions, when executed, further cause the at least one processor to:
determine that the object element of a second triadic data structure generated from the experience event and added to the semiotic model is a pointer to the same node of the first one of the plurality of ontologies;
determine that the sign element of the second triadic data structure is a pointer to the same node of the second one of the plurality of ontologies; and
in response to the determination, link the pointer corresponding to the interpretant element of the first triadic data structure to a pointer to a node of a given one of the plurality of ontologies corresponding to the interpretant element of the second triadic data structure.

19. The system of claim 1, wherein the instructions that cause the at least one processor to set the habit flag based on the predetermined condition comprise instructions to:
transmit a notification to the user to present the triadic data structure as a hypothesis for validation based on user input; and
in response to determining that the hypothesis has been validated by the user, set the habit flag for the triadic data structure.

20. A non-transitory computer readable medium for storing computer code comprising instructions, when executed by at least one processor, cause the at least one processor to:
access time-series data associated with a user;
access domain knowledge rules governing interpretation of the time-series data in building a semiotic model of the user;
extract an experience event from the time-series data based on at least one of the domain knowledge rules being satisfied;
generate, based on the experience event, a triadic data structure comprising triadic-relational elements, wherein the triadic-relational elements include an object element, a sign element, and an interpretant element, and wherein the interpretant element of the triadic data structure is determined based on an observation associated with the at least one domain knowledge rule;
identify an object of interest that appears in the environment of the user during the experience event based on the time-series data associated with the experience event, wherein the object element of the triadic data structure is determined based on the object of interest;
add the triadic data structure to the semiotic model of the user; and
set a habit flag of the triadic data structure in the semiotic model in response to determining that a predetermined condition associated with the triadic data structure is satisfied, wherein the habit flag indicates that the triadic data structure represents an interpretive habit of the user.
